(19) United States
(12) Patent Application Publication
(10) Pub. No.: US 2026/0138116 A1
(43) Pub. Date: May 21, 2026

(54) SOLAR-THERMAL MICROJET ARRAY

(71) Applicant: National Technology & Engineering Solutions of Sandia, LLC, Albuquerque, NM (US)

(72) Inventor: Jeffrey Daniel Engerer, Cedar Crest, NM (US)

(21) Appl. No.: 19/076,405

(22) Filed: Mar. 11, 2025

Related U.S. Application Data
(63) Continuation-in-part of application No. 18/953,338, filed on Nov. 20, 2024.

(51) Int. Cl. B01J 19/26; B01J 4/00

(52) U.S. Cl. CPC B01J 19/26; B01J 4/002; B01J 2204/002

(57) ABSTRACT

An apparatus and method for enhancing mass-transfer rate of reactive species. The apparatus includes a microjet array spaced from a target. The target is contained within a holder. The microjet array directs a reactive flow to a reactive surface of the target.

### CROSS-REFERENCE TO RELATED APPLICATION

This application is a Continuation-in-Part of U.S. patent application Ser. No. 18/953,338, filed Nov. 20, 2024, and entitled “Solar-Thermal Microfluidic Spinning Disc Reactor,” which is incorporated herein by reference in its entirety.

### STATEMENT OF GOVERNMENT INTEREST

This invention was made with United States Government support under Contract No. DE-NA0003525 between National Technology & Engineering Solutions of Sandia, LLC and the United States Department of Energy. The United States Government has certain rights in this invention.

### BACKGROUND

### 1. Field

The present disclosure relates generally to solar-thermal testing and more specifically to enhancing rate of mass diffusion of reactive species.

### 2. Background

Fast reactions between gases and solids are often limited by the rate of mass diffusion from the gas phase to the reactive surface. Methods to enhance mass diffusion are commonly leveraged to increase reaction rates to the kinetic limit for many applications. One example is chemical reactors, where faster reaction rates enhance product throughput and/or some quality metric. An additional example is scientific apparatuses, where reaction kinetics can be measured directly.

Techniques for enhancing mass-transfer rate include microfluidics and spinning disc reactors. Each has benefits and downfalls.

Microfluidic phenomena are leveraged to generate fluid bearings for carrying rotational and directional loads. These fluid bearings generally operate on at least one bar of pressure and result in self-stabilizing microchannel on the order of 1-100 microns in size. Shortfalls or difficulties with the use of microfluidics to enhance mass-transfer rate include the requirement for a dimensionally stable system with tight tolerances to avoid unintentional contact between the wall bounding the microfluidic flow. Microfluidics are also generally temperature limited, using low temperature materials incapable of reactions at extreme temperature much above 1000° C.

Spinning disc reactors are commonly used for chemical processing in a temperature-controlled environment, scientific studies of fluid flow and combustion, and for chemical-vapor deposition. Solar-thermal reactors can reach heat fluxes of 1 MW/m2 and temperatures exceeding 2000° C. that are difficult to obtain by other methods. Shortfalls or difficulties with the use of spinning disc reactors to enhance mass-transfer rate include the design of a high temperature apparatus capable of securing the spinning disc beyond the softening, melting, and failure points of most common materials. Also spinning discs enhance mass transfer rate by spinning at higher rates, but with diminishing returns at high RPM's eventually reaching the mechanical limits of all known refractory materials and of rotational bearing technology.

Therefore, it would be desirable to have a method and apparatus that take into account at least some of the issues discussed above, as well as other possible issues.

### SUMMARY

An illustrative embodiment provides an apparatus for enhancing mass-transfer rate of reactive species. The apparatus includes a microjet array and a target contained within a holder. The microjet array directs a reactive flow. A reactive surface of the target is spaced from the microjet array. The reactive flow is directed to impinge the reactive surface.

Another illustrative embodiment provides an apparatus for enhancing mass-transfer rate of reactive species. The apparatus includes a microjet array and a holder containing a target. The microjet array is machined into a solar transparent window. A position of the holder and the target relative to the microjet array is adjustable to maintain a consistent space between the microjet array and the target.

Another embodiment provides a method for enhancing mass-transfer rate of reactive species. The method includes spacing a target from a microjet array. A reactive surface of the target is impinged by a reactive flow directed by the microjet array. The reactive flow may be heated and/or pressurized.

The features and functions can be achieved independently in various examples of the present disclosure or may be combined in yet other examples in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of a solar-thermal microfluidic spinning disc reactor in accordance with an illustrative embodiment;

FIG. 2 is an illustration of a solar-thermal microfluidic spinning disc reactor in accordance with an illustrative embodiment;

FIG. 3 is an illustration of a solar-thermal microfluidic spinning disc reactor in accordance with an illustrative embodiment;

FIG. 4 is an illustration of a cross-section view of a solar-thermal microfluidic spinning disc reactor in accordance with an illustrative embodiment;

FIG. 5 is an illustration of a solar-thermal microfluidic spinning disc reactor in accordance with an illustrative embodiment;

FIG. 6 is an illustration of rotor of a solar-thermal microfluidic spinning disc reactor in accordance with an illustrative embodiment;

FIG. 7 is an illustration of a flowchart of a process for enhancing mass-transfer rate of reactive species in accordance with an illustrative embodiment;

FIG. 8 is an illustration of an apparatus for enhancing mass-transfer rate of reactive species in accordance with an illustrative embodiment;

FIG. 9 is an illustration of an apparatus for enhancing mass-transfer rate of reactive species in accordance with an illustrative embodiment; and

FIG. 10 is an illustration of a flowchart of a process for enhancing mass-transfer rate of reactive species in accordance with an illustrative embodiment.

### DETAILED DESCRIPTION

The illustrative embodiments recognize and take into account one or more different considerations. The issues recognized by the different illustrative embodiments are described herein.

For example, the illustrative embodiments recognize and take into account that fast reactions between gases and solids are often limited by the rate of mass diffusion from the gas phase to the reactive surface.

The illustrative embodiments recognize and take into account that methods to enhance mass diffusion, for example, chemical reactors and/or scientific apparatus are commonly leveraged to increase reaction rates to the kinetic limit and that techniques for enhancing mass-transfer rate include microfluidics and spinning disc reactors.

The illustrative embodiments recognize and take into account that using microfluidics to enhance mass-transfer rate requires a dimensionally stable system with tight tolerances in order to avoid unintentional contact between the wall bounding the microfluidic flow. The illustrative embodiments also recognize and take into account that microfluidics are generally temperature limited, using low-temperature materials incapable of reactions at extreme temperature much above 1000° C.

The illustrative embodiments recognize and take into account that using spinning disc reactors to enhance mass-transfer rate requires a high-temperature apparatus capable of securing the spinning disc beyond the softening, melting and failure points of most common materials. The illustrative embodiments also recognize and take into account that spinning discs enhance mass-transfer rate by spinning at higher rates, but with diminishing returns at high RPMs, eventually reaching the mechanical limits of all known refractory materials and of rotational bearing technology.

The illustrative embodiments combine the technologies of microfluidics and spinning disc reactors to overcome the issues identified above.

The illustrative embodiments include microfluidic phenomena and spinning disc reactions to enhance mass-transfer rates better than either technology can separately. Solar thermal technology creates a localized heating at the surface of the heterogeneous reaction, enabling higher process efficiency and the use of common, lower temperature materials for the supporting infrastructure (spinning shaft, bearings, etc.). Microfluidics enhance mass transfer to rates inaccessible to traditional solar thermal processes (e.g., pressure chambers, packed bed reactors).

The illustrative embodiments recognize and take into account that concentrated solar thermal energy is a method for heating targets for a variety of processes such as energy production, biofuels, and chemical processing. These technologies can heat material to extreme temperature (>2000° C.) at high densities (>100 W/cm²).

The illustrative embodiments recognize and take into account that solar transparent windows are often used to aid solar-thermal processes that are enhanced by control of the environment, including pressure and gas makeup where solar energy is transferred into a sealed vessel.

The illustrative embodiments recognize and take into account that high reaction rates are desirable and require high mass conductance (rapid transfer of reactant gas to a heated surface). The illustrative embodiments recognize and take into account that microjet arrays demonstrate enhanced energy and mass transfer and can be designed for subsonic, sonic, or supersonic flow, where supersonic nozzles often require an energy source to obtain ideal operating conditions.

The illustrative embodiments maintain a microfluidic gap amidst surface volatilization with a pressurized fluid bearing and mechanical forces acting on a rotor containing a target having a reactive surface. The illustrative embodiments create a subsonic or supersonic flow with a microjet array and mechanical forces acting on a target that impinges a reactive surface of the target. The illustrative embodiments generate uniform reaction rates across the reactive surface. The illustrative embodiments may preheat reactive gases and cool a solar thermal window of stator spaced from the rotor.

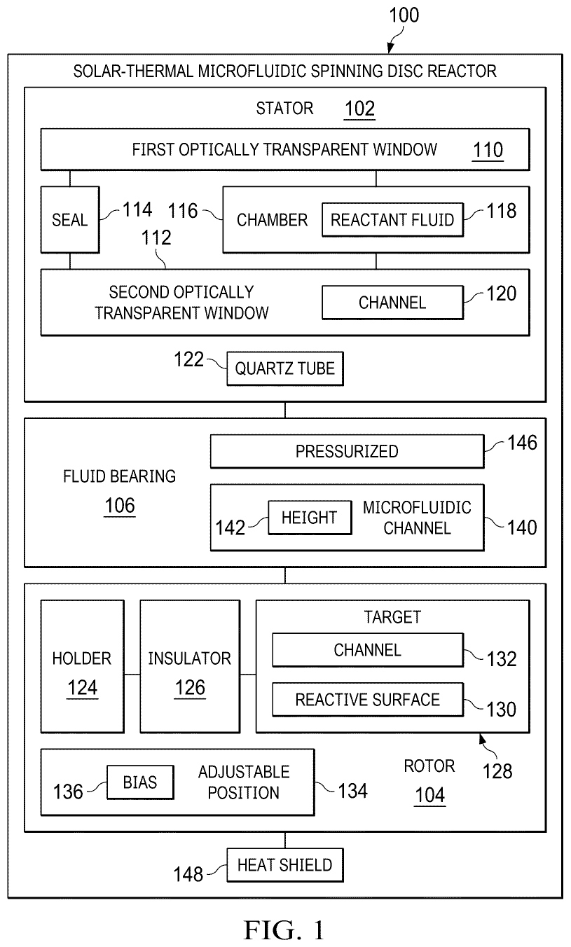

With reference now to the figures and, in particular, with reference to FIG. 1, an illustration of a block diagram of a solar-thermal microfluidic spinning disc reactor is depicted in accordance with an illustrative example. Solar-thermal microfluidic spinning disc reactor 100 includes stator 102, rotor 104, and fluid bearing 106 positioned between stator 102 and rotor 104 in this illustrative example. The illustration of solar-thermal microfluidic spinning disc reactor 100 in FIG. 1 is not meant to imply physical or architectural limitations to the manner in which an illustrative example may be implemented.

In this illustrative example, stator 102 is transparent and includes first optically transparent window 110 spaced from second optically transparent window 112. First optically transparent window 110 is sealed to second optically transparent window 112 with seal 114. First optically transparent window 110 is spaced from second optically transparent window 112 and sealed to form chamber 116. Chamber 116 contains reactant fluid 118. Non-limiting examples of reactant fluid 118 include methane, oxygen, water, carbon dioxide, petroleum products, and natural gas having properties such as chemical reactivity, oxidizing, reducing high thermal conductivity and high diffusivity. Second optically transparent window 112 includes channel 120. Channel 120 provides a conduit for supplying reactant fluid 118 to a reactive surface of a target of rotor 104.

Stator 102 is heated, for example, using irradiation from solar thermal or laser. Stator 102 can be heated to temperatures in the range of 3000 degrees Celsius. It is not necessary to rotate stator 102. The transparency of stator 102 allows reactant fluid 118 contained within chamber 116 to heat up and flow through channel 120 towards rotor 104. First optically transparent window 110 spaced from second optically transparent window 112 may be in the form of quartz tube 122. Quartz tube 122 may include a reactant fluid and a channel for the reactant fluid to flow when heated.

In this illustrative example, rotor 104 is spaced from stator 102 by fluid bearing 106. Rotor 104 includes holder 124. Holder 124 holds insulator 126. Insulator 126 contains target 128. Insulator 126 may include a sleeve to contain target 128. Target 128 is a reactive material. Non-limiting examples of the reactive material of target 128 include metals, refractory alloys, carbon-based materials, catalytic materials, decomposing biofuel feedstock, composites, semiconductors, and porous materials. Target 128 includes reactive surface 130. Reactive surface 130 is the surface of the reactive material of target 128 that faces stator 102. Reactive surface 130 is spaced from stator 102 with fluid bearing 106. Target 128 may include channel 132 for supplying reactant fluid 118 to reactive surface 130. Rotor 104 has an adjustable position 134 relative to stator 102. Adjustable position 134 includes bias 136. Bias 136 urges rotor 104 towards stator 102. Adjustable position 134 allows bias 136 to reposition rotor 104 and thus reactive surface 130 relative to quartz tube 122 or second optically transparent window 112 of stator 102.

Fluid bearing 106 is a fluid flow of reactant fluid 118. Fluid bearing 106 is positioned between stator 102 and rotor 104. Fluid bearing 106 forms microfluidic channel 140. Microfluidic channel 140 has height 142. Non-limiting examples of the composition of fluid bearing 106 may include methane, oxygen, water, carbon dioxide, petroleum products, and natural gas. Height 142 corresponds to the distance between stator 102 and rotor 104. Fluid bearing 106 is pressurized 146 in order to maintain height 142 of microfluidic channel 140. The pressure of fluid bearing 106 urges rotor 104 away from stator 102 in opposition to bias 136 to maintain height 142 of microfluidic channel 140.

Heat shield 148 surrounds rotor 104. Heat shield 148 provides protection from the heat irradiation applied to stator 102.

In use, rotor 104 is rotated with respect to stator 102. Bias 136 urges rotor and thus reactive surface 130 towards stator 102. Fluid bearing 106 is pressurized 146 and opposes bias 136. In other words, fluid bearing 106 is pressurized in order to maintain height 142 of microfluidic channel 140. Reactant fluid 118 flows through channel 120 or channel 132 or both to microfluidic channel 140 in order to react with reactive surface 130.

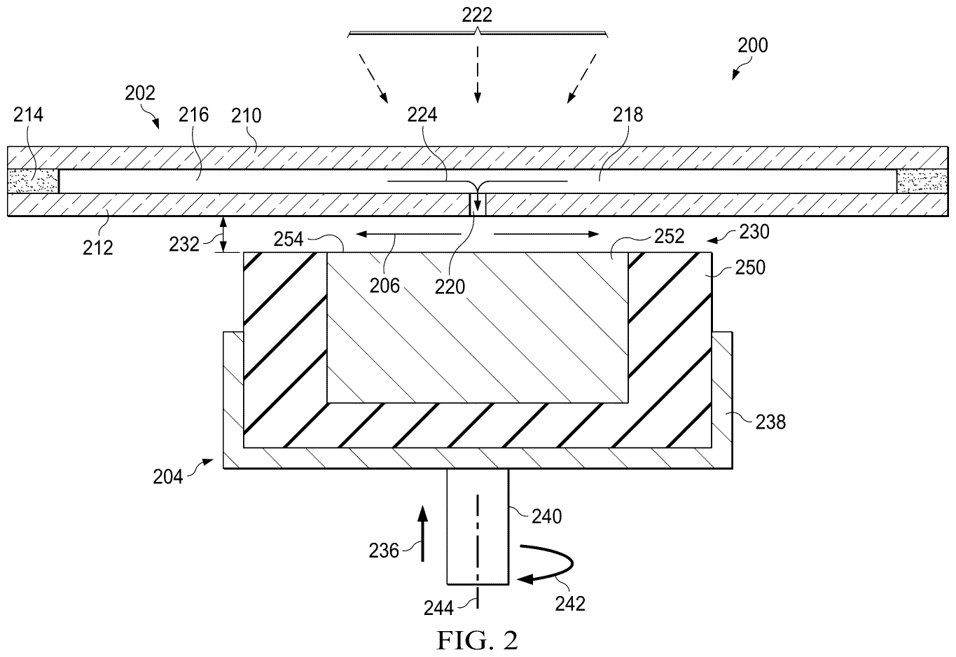

With reference next to FIG. 2, an illustration of a solar-thermal microfluidic spinning disc reactor is depicted in accordance with an illustrative embodiment. In this illustrative example and the illustrative examples that follow, the same reference numeral may be used in more than one figure. This reuse of a reference numeral in different figures represents the same element in the different figures. The components illustrated in FIG. 2 are examples of physical implementations of a solar-thermal microfluidic spinning disc reactor 100, stator 102, fluid bearing 106, and rotor 104 shown in block form in FIG. 1.

As illustrated, solar-thermal microfluidic spinning disc reactor 200 includes stator 202, rotor 204, and fluid bearing 206.

Stator 202 includes first optically transparent window 210 spaced from second optically transparent window 212. First optically transparent window 210 is sealed to second optically transparent window 212 with seal 214. First optically transparent window 210 spaced from and sealed to second optically transparent window 212 forms chamber 216. Reactant fluid 218 is contained within chamber 216. Second optically transparent window 212 includes channel 220. Irradiation 222 in the form of, for example, solar thermal or laser, applied to stator 202 creates reactive flow 224 from chamber 216, through channel 220, toward rotor 204 to create fluid bearing 206. Fluid bearing 206 forms microfluidic channel 230. Microfluidic channel 230 has height 232. Height 232 corresponds to the distance between stator 202 and rotor 204. Fluid bearing 206 is pressurized in order to maintain height 232 of microfluidic channel 230. The pressure of fluid bearing 206 urges rotor 204 away from stator 202 in opposition to bias 236 applied to rotor 204 to maintain height 232 of microfluidic channel 230. Bias 236 is applied to rotor 204 with, for example, springs, a stepper motor driven linear actuator, or any linear actuator.

Rotor 204 includes holder 238. Holder 238 has rotating shaft 240. Rotation 242 of rotating shaft 240 and thus rotor 204 about axis 244 can be accomplished by, for example, a motor. Holder 238 holds insulator 250. Insulator 250 contains target 252. Insulator 250 may also include a sleeve to contain target 252. Target 252 is a reactive material. Target 252 includes reactive surface 254. Reactive surface 254 is the surface of the reactive material of target 252 that faces stator 202. Reactive surface 254 is spaced from stator 202 by fluid bearing 206 forming microfluidic channel 230. Reactant fluid 218 heated within chamber 216 creates reactive flow 224 which flows through microfluidic channel 230 as fluid bearing 206 to react with reactive surface 254. Rotor 204 has an adjustable position relative to stator 202 along axis 244. Bias 236 urges rotor 204 towards stator 202. Fluid bearing 206 urges rotor 204 away from stator 202 in opposition to bias 236 to maintain height 232 of microfluidic channel 230.

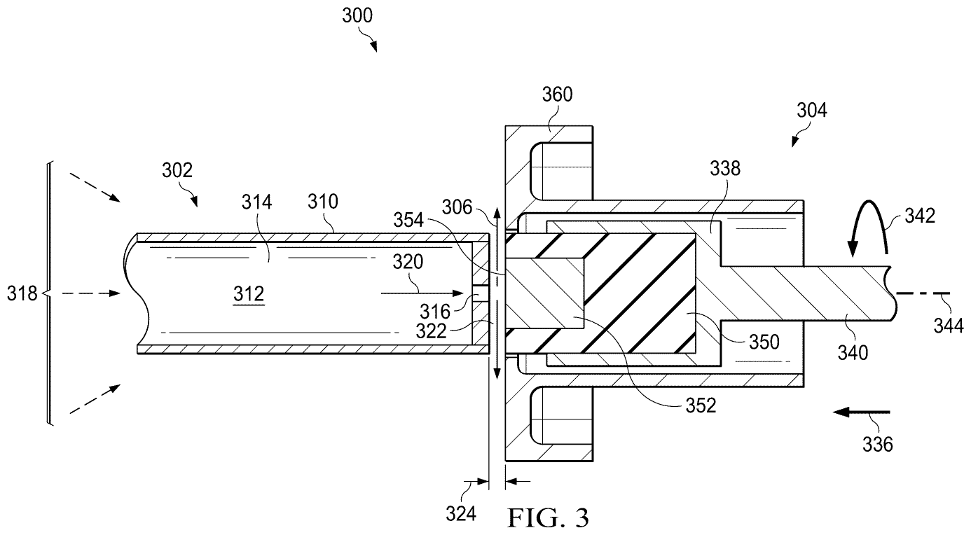

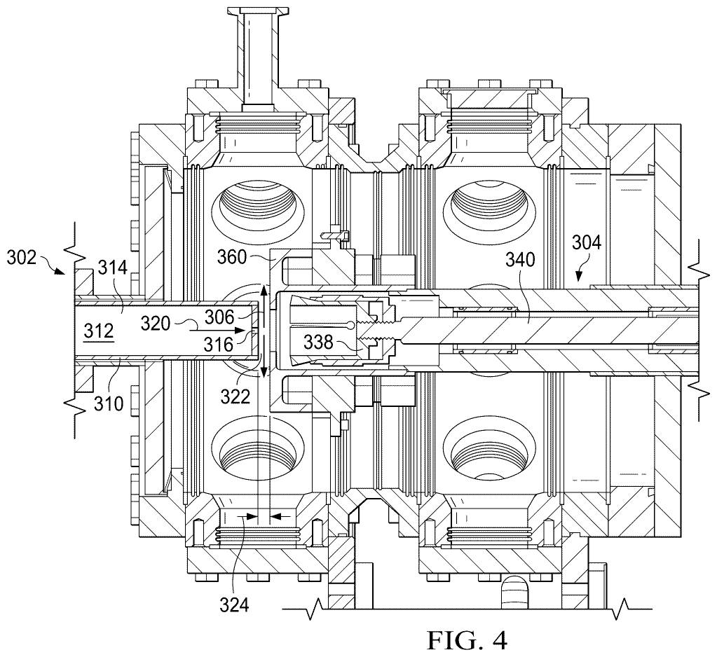

With reference next to FIGS. 3-4, illustrations of a solar-thermal microfluidic spinning disc reactor is depicted in accordance with an illustrative embodiment. The components illustrated in FIGS. 3-4 are examples of physical implementations of a solar-thermal microfluidic spinning disc reactor 100, stator 102, fluid bearing 106, and rotor 104 shown in block form in FIG. 1. FIG. 4 illustrates a solar-thermal microfluidic spinning disc reactor contained within a housing in a cross-section view.

As illustrated, solar-thermal microfluidic spinning disc reactor 300 includes stator 302, rotor 304, and fluid bearing 306.

Stator 302 includes quartz tube 310. Quartz tube 310 forms chamber 312. Reactant fluid 314 is contained within chamber 312. Quartz tube 310 includes channel 316. Irradiation 318 applied to quartz tube 310 creates reactive flow 320 from chamber 312, through channel 316, toward rotor 304 to create fluid bearing 306. Fluid bearing 306 forms microfluidic channel 322. Microfluidic channel 322 has height 324. Height 324 corresponds to the distance between stator 302 and rotor 304. Fluid bearing 306 is pressurized in order to maintain height 324 of microfluidic channel 322.

Rotor 304 includes holder 338. Holder 338 has rotating shaft 340. Rotation 342 of rotating shaft 340 and thus rotor 304 about axis 344 can be accomplished by a motor. Holder 338 holds insulator 350. Insulator 350 contains target 352 (target 352 not shown in FIG. 4). Target 352 is a reactive material. Target 352 includes reactive surface 354. Reactive surface 354 is the surface of the reactive material of target 352 that faces stator 302. Reactive surface 354 is spaced from stator 302 by fluid bearing 306. Reactant fluid 314 heated within chamber 312 creates reactive flow 320 which flows through microfluidic channel 322 as fluid bearing 306 to react with reactive surface 354. Rotor 304 has an adjustable position relative to stator 302 along axis 344. Bias 336 on rotor 304 urges rotor 304 towards stator 302. Fluid bearing 306 urges rotor 304 away from stator 302 in opposition to bias 336 to maintain height 324 of microfluidic channel 322. Heat shield 360 surrounds rotor 304. Heat shield 360 provides protection from heat irradiation 318 applied to stator 302. Heat shield 360, for example, may be water cooled copper or other means known to those skilled in the art.

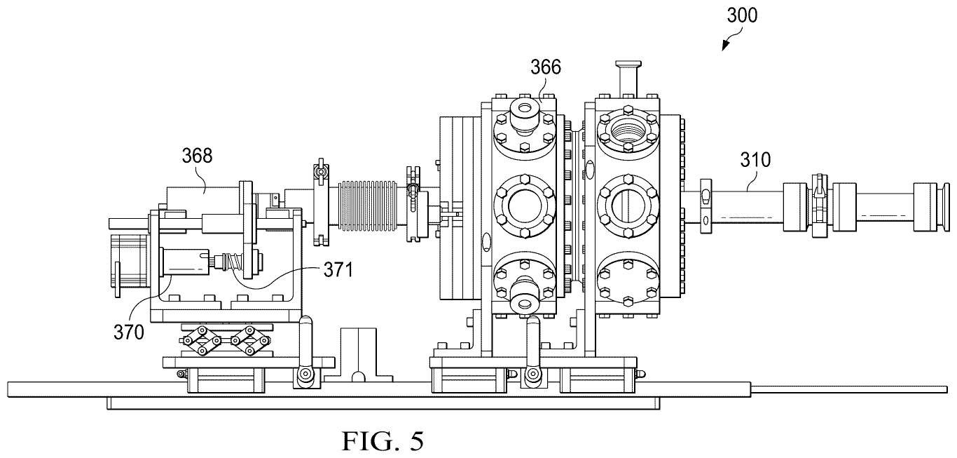

With reference next to FIG. 5, and as shown in FIG. 4, solar-thermal microfluidic spinning disc reactor 300 may be contained within housing 362. Quartz tube 310 extends from housing 366 to be exposed to irradiation. Motor 368 applies rotation to rotating shaft 340 of rotor 304. Stepper motor driven linear actuator 370 and spring 371 apply bias 336 to rotor 304.

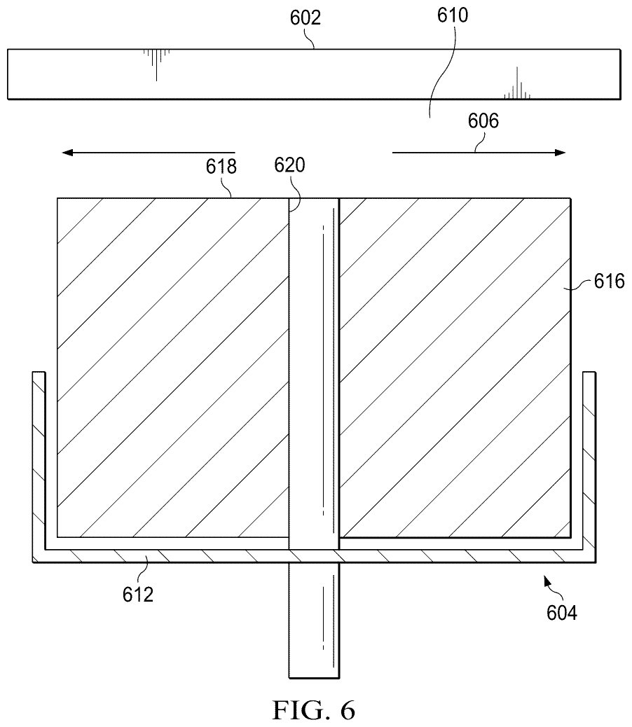

With reference next to FIG. 6, an illustration of a rotor of a solar-thermal microfluidic spinning disc reactor is depicted in accordance with an illustrative embodiment. The components illustrated in FIG. 6 are examples of physical implementations of a rotor 104 shown in block form in FIG. 1.

In this illustrative example, rotor 604 is spaced from stator 602 by fluid bearing 606 forming microfluidic channel 610. Rotor 604 includes holder 612. Holder 612 holds target 616. Target 616 is a reactive material. Target 616 includes reactive surface 618. Reactive surface 618 is the surface of the reactive material of target 616 that faces stator 602. Reactive surface 618 is spaced from stator 602 with fluid bearing 606. Target 616 includes channel 620 for supplying a reactant fluid to reactive surface 618. Heated reactant fluid creates a reactive flow which flows through microfluidic channel 610 as fluid bearing 606 to react with reactive surface 618.

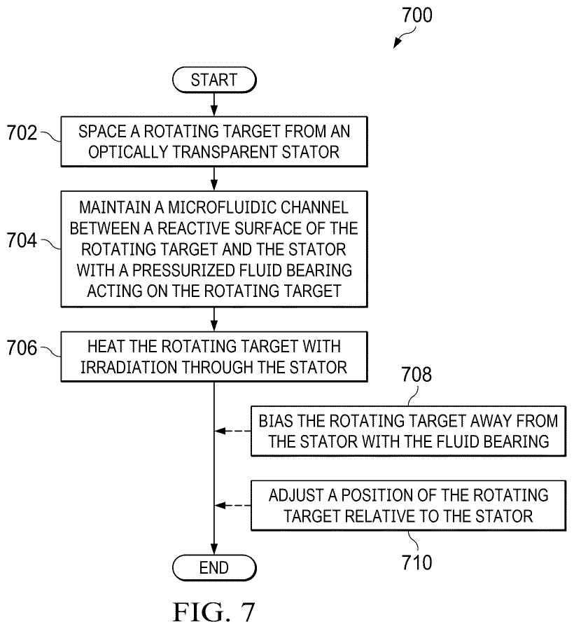

With reference next to FIG. 7, an illustration of a flowchart of a process 700 for enhancing mass-transfer rate of reactive species is depicted in accordance with an illustrative embodiment. The method depicted in FIG. 7 may be used in conjunction with the solar-thermal microfluidic spinning disc reactor depicted in FIGS. 1-6.

The process begins by spacing a rotating target from an optically transparent stator (operation 702). The target is held in a rotor that is biased towards the stator. The process continues by maintaining a microfluidic channel between a reactive surface of the rotating target and the stator (operation 704). The microfluidic channel is maintained with a pressurized fluid bearing acting on the rotating target against the bias acting on the rotor. At operation 706, the process heats the rotating target with irradiation through the stator. At operation 708, the rotating target is biassed away from the stator with the fluid bearing to maintain a height of the microfluidic channel. At operation 710, a position of the rotating target relative to the stator is adjusted toward the stator to affect the height of the microfluidic channel.

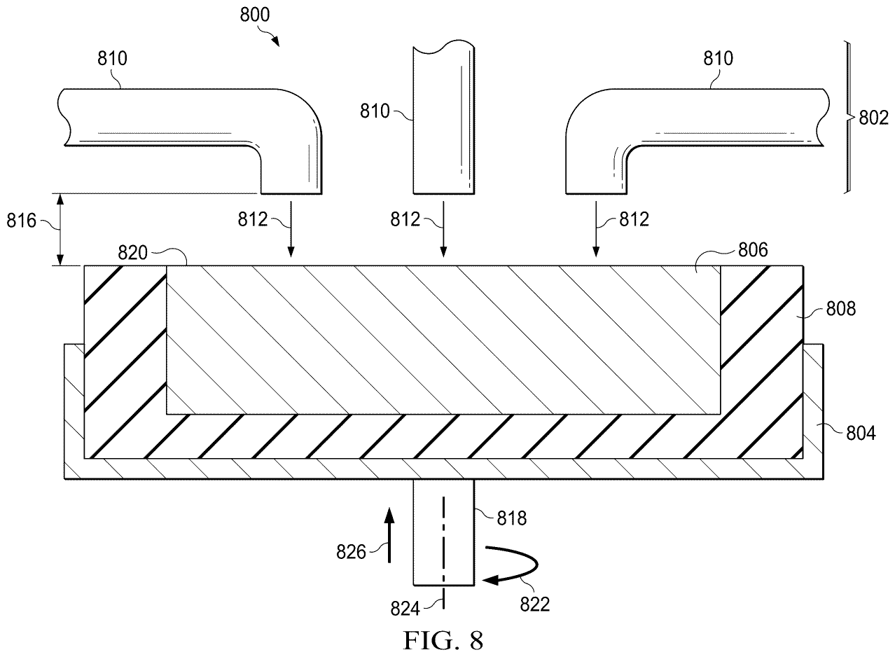

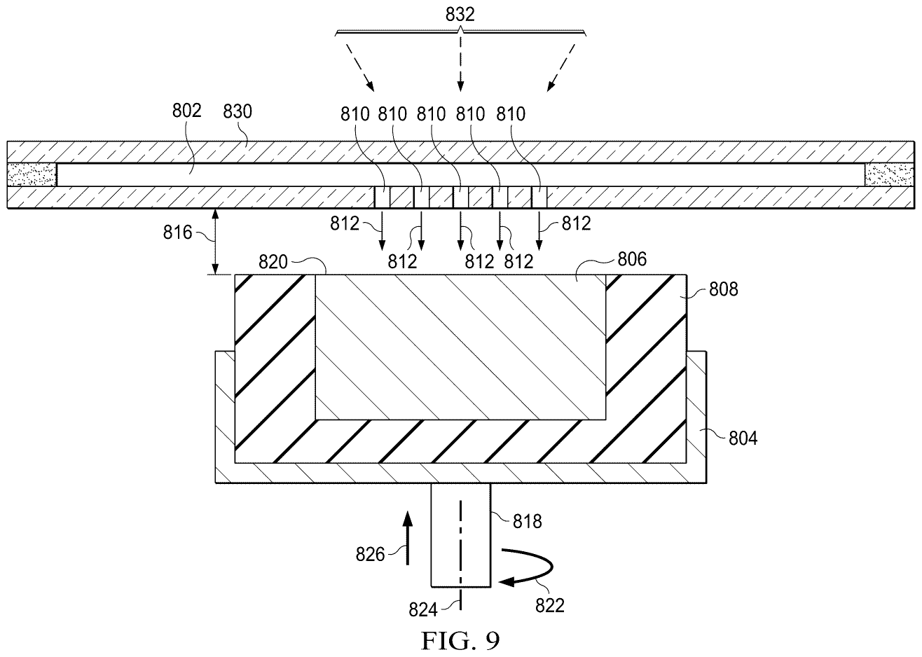

With reference next to FIGS. 8 and 9, an illustration of an apparatus for enhancing mass-transfer rate of reactive species is depicted in accordance with an illustrative embodiment. The components illustrated in FIGS. 8 and 9 are examples of physical implementations of a first optically transparent window 110, a second optically transparent window 112, a holder 124, an insulator 126, and a target 128 shown in block form in FIG. 1.

As illustrated, apparatus 800 for enhancing mass-transfer rate of reactive species includes microjet array 802, holder 804, and target 806.

Target 806 is a reactive material. Target 806 includes reactive surface 820. Reactive surface 820 is the surface of the reactive material of target 806 that faces microjet array 802. Reactive surface 820 is spaced from microjet array 802 a consistent space 816 in order to optimize the mass-transfer rate of target 806. Holder 804 holds insulator 808. Insulator 808 contains target 806. Holder 804 includes shaft 818. Shaft 818 may be a rotating shaft. Rotation 822 of shaft 818 and thus holder 804 about axis 824 can be accomplished by, for example, a motor. Holder 804 has an adjustable position relative to microjet array 802. Bias 826 urges holder 804 towards microjet array 802. The adjustability of holder 804 allows bias 826 to reposition holder 804 and thus reactive surface 820 relative to microjet array 802. Bias 826 is applied to holder 804 with, for example, springs or a stepper motor driven linear actuator, or any linear actuator.

Microjet array 802 includes at least one microjet 810 or may include a plurality of microjets 810. Each microjet 810 of a plurality may be evenly spaced across reactive surface 820. In other words, relative to the area of reactive surface 820, each microjet 810 of a plurality of microjets 810 may be evenly spaced relative to each other and to the surface area of reactive surface 820. The microjets of microjet array 802 may be arranged linearly or may be arranged, for example, in concentric rings. In all arrangements, each microjet 810 of microjet array 802 may be evenly spaced relative to each other, thus over reactive surface 820 as well. Alternatively, each microjet 810 of microjet array 802 may not be evenly spaced relative to each other or across reactive surface in response to a desired mass-transfer rate for a particular reactive species of a particular target 806.

Microjet array 802 directs reactive flow 812. Reactive flow 812 can be created by any of the previous described processes. Reactive flow 812 may be heated and/or pressurized. Microjet array 802 directs reactive flow 812 generally perpendicular to reactive surface 820 of target 806. Reactive flow 812 impinges reactive surface 820 in order to enhance the mass-transfer rate of the reactive species that is target 806. A pressure of reactive flow 812 urges holder 804 away from microjet array 802 in opposition to bias 826 applied to holder 804 to maintain consistent space 816 between microjet array 802 and reactive surface 820.

With reference next to FIG. 9, apparatus 900 for enhancing mass-transfer rate of reactive species includes microjet array 802 machined into solar transparent window 830. Microjet array 802 may be contained within solar transparent window 830. Irradiation 832 in the form of, for example, solar thermal or laser, applied to solar transparent window 830 creates reactive flow 812. Microjet array 802 directs reactive flow through microjets 810 toward target 806 such that reactive flow 812 impinges reactive surface 820 of target 806. Microjet array 802 directs reactive flow 812 generally perpendicular to reactive surface 820 of target 806.

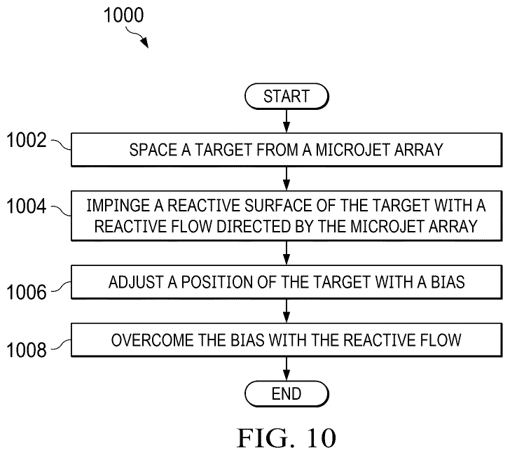

With reference next to FIG. 10, an illustration of a flowchart of a process 1000 for enhancing mass-transfer rate of reactive species is depicted in accordance with an illustrative embodiment. The method depicted in FIG. 10 may be used in conjunction with the apparatus for enhancing mass-transfer rate of reactive species depicted in FIGS. 8-9.

The process begins by spacing a spacing a target from a microjet array (operation 1002). The target is held in a holder. The ideal spacing between the target and the microjet array results in optimizing the mass transfer rate of the reactive species that is the target. The process continues by impinging a reactive surface of the target with a reactive flow (operation 1004). The reactive flow is directed by the microjet array toward the reactive surface. At operation 1006, the process adjusts the position of the holder and target relative to the microjet array with a bias on the holder. The bias on the holder urges the holder and the target toward the microjet array. Adjusting the position of the holder and target with the bias maintains a consistent space between the microjet array and the reactive surface of the target. At operation 1008, the consistent space is maintained by overcoming the bias with the reactive flow. The reactive flow may be heated and/or pressurized which urges the holder away from the microjet array to maintain the consistent space between the microjet array and the reactive surface of the target.

In some alternative implementations of an illustrative example, the function or functions noted in the blocks of the illustrated flowcharts may not be necessary or may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

As used herein, the phrase “a number” means one or more. The phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item C. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component. Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. An apparatus for enhancing mass-transfer rate of reactive species, the apparatus comprising:
a microjet array for directing a reactive flow; and
a target contained within a holder, a reactive surface of the target spaced from the microjet array, the reactive flow directed to impinge the reactive surface.

2. The apparatus of claim 1, wherein the holder comprises an insulator, the insulator positioned between the target and the holder.

3. The apparatus of claim 1, wherein the target comprises a reactive material or catalyst.

4. The apparatus of claim 1, wherein the reactive flow is perpendicular to the reactive surface.

5. The apparatus of claim 1, wherein the microjet array is machined into a solar transparent window.

6. The apparatus of claim 1, wherein a position of the holder and the target relative to the microjet array is adjustable to maintain a consistent space between the microjet array and the reactive surface.

7. The apparatus of claim 1, wherein the holder is biased towards the microjet array and the reactive flow is pressurized against the bias to maintain a consistent space between the microjet array and the reactive surface.

8. The apparatus of claim 1, wherein the microjet array comprises at least one microjet.

9. The apparatus of claim 1, wherein the microjet array comprises a plurality of microjets, wherein each microjet of the plurality of microjets directs a respective reactive flow parallel to a reactive flow of each of the other microjets.

10. The apparatus of claim 9, wherein each microjet of the plurality of microjets is evenly spaced across the reactive surface.

11. An apparatus for enhancing mass-transfer rate of reactive species, the apparatus comprising:
a microjet array machined into a solar transparent window; and
a holder for containing a target, wherein a position of the holder and the target relative to the microjet array is adjustable to maintain a consistent space between the microjet array and the target.

12. The apparatus of claim 11, wherein the holder is biased towards the microjet array and a reactive flow directed by the microjet array is pressurized against the bias to maintain the consistent space between the microjet array and a reactive surface of the target.

13. The apparatus of claim 11, wherein the microjet array is configured to direct a reactive flow to impinge on the target, and wherein the holder is rotatable on an axis parallel with the reactive flow.

14. The apparatus of claim 11, wherein the microjet array directs a reactive flow perpendicular to a reactive surface of the target.

15. The apparatus of claim 11, wherein the microjet array comprises at least one microjet configured to direct a reactive flow to a reactive surface of the target.

16. The apparatus of claim 11, wherein the microjet array comprises a plurality of microjets, wherein each microjet of the plurality of microjets directs a reactive flow parallel to a reactive flow of each of the other microjets.

17. The apparatus of claim 16, wherein each microjet of the plurality of microjets is evenly spaced across a reactive surface of the target.

18. A method for enhancing mass-transfer rate of reactive species, the method comprising:
spacing a target from a microjet array; and
impinging a reactive surface of the target with a reactive flow directed by the microjet array.

19. The method of claim 18, further comprising adjusting a position of the target relative to the microjet array toward the microjet array with a bias to maintain a consistent space between the microjet array and the reactive surface of the target.

20. The method of claim 19, further comprising overcoming the bias with the reactive flow to maintain the consistent space between the microjet array and the reactive surface of the target.
